(19) United States
(12) Patent Application Publication
(10) Pub. No.: US 2004/0106319 A1
(43) Pub. Date: Jun. 3, 2004

(54) Terminal for a zero insertion force connector

(76) Inventor: Kao Mao Sen, Taipei Hsien (TW)

Correspondence Address: TROP PRUNER & HU, PC, 8554 KATY FREEWAY, SUITE 100, HOUSTON, TX, 77024, US

(21) Appl. No.: 10/456,229

(22) Filed: Jun. 6, 2003

(30) Foreign Application Priority Data
Dec. 2, 2002 (TW) 091219420

(51) Int. Cl. H01R 13/625

(52) U.S. Cl. 439/342

(57) ABSTRACT

A terminal for a zero insertion force connector includes a body with a head, a pair of prongs extending from the head in a longitudinal direction and spaced apart from each other, and a pair of opposing spring arms that respectively extend from the prongs in a transverse direction relative to the longitudinal direction. The spring arms have contact ends that define a gap therebetween. The spring arms together with the prongs are resiliently pushed away from each other by insertion of a pin therebetween.

### CROSS-REFERENCE TO RELATED APPLICATION

This application claims priority of Taiwanese Application No. 091219420, filed on Dec. 2, 2002.

### BACKGROUND OF THE INVENTION

1. Field of the Invention

This invention relates to a terminal for a zero insertion force (ZIF) connector which is adapted to be surface mounted on a printed circuit board for mounting of a center processing unit (CPU) thereon.

2. Description of the Related Art

FIGS. 1 and 2 illustrate a conventional terminal 9 for a ZIF connector (not shown) that is adapted to be surface mounted on a printed circuit board (not shown) for mounting of a CPU (not shown) thereon. The terminal 9 is adapted to contact electrically a pin 8 on the CPU, and has a terminal body 90 that has a tail 92, a head 93 opposite to the tail 92, and a pair of spring arms 91 that extend from the head 93 and that have curved sections 915 which cooperatively define a first gap 914 therebetween, and contact ends 912 which cooperatively define a second gap 916 therebetween. The terminal 9 is movable together with the ZIF connector between a first position, in which the pin 8 is disposed in the first gap 914, and a second position, in which the pin 8 is disposed in the second gap 916 and is resiliently clamped by the contact ends 912 of the spring arms 91.

The conventional terminal 9 is disadvantageous in that the spring arms 91 tend to suffer from elastic fatigue after a period of use, which can result in poor electrical contact between the contact ends 912 of the spring arms 91 and the pin 8.

### SUMMARY OF THE INVENTION

Therefore, the object of the present invention is to provide a terminal for a zero insertion force connector that is capable of overcoming the aforesaid drawback of the prior art.

According to the present invention, there is provided a terminal for a zero insertion force connector. The terminal is adapted to be electrically connected to a pin on an electronic device, and comprises: a terminal body that extends in a longitudinal direction and that has a tail, a head opposite to the tail, and a pair of resilient prongs extending from the head in the longitudinal direction and spaced apart from each other. Each of the prongs has a distal end that is distal from the head. The terminal body further has a pair of opposing spring arms that extend outwardly an respectively from the distal ends of the prongs in a transverse direction relative to the longitudinal direction. The spring arms have middle sections that cooperatively define a first gap therebetween, and contact ends that extend respectively from the middle sections, that are distal from the prongs, and that cooperatively define a second gap therebetween. The first gap has a width greater than the diameter of the pin. And the second gap has a width less than the diameter of the pin. When the terminal is moved together with the ZIF connector in the transverse direction from a first position, in which the pin is disposed in the first gap and separates from the spring arms, to a second position, in which the pin is disposed in the second gap, the spring arms together with the prongs are resiliently pushed by the pin to move away from each other, which, in turn, results in a restoring force to clamp the pin between the contact ends of the spring arms.

### BRIEF DESCRIPTION OF THE DRAWINGS

In drawings which illustrate an embodiment of the invention,

FIG. 1 is a side view of a conventional terminal for a zero insertion force connector;

FIG. 2 is a schematic view to illustrate the configuration of a pair of spring arms of the terminal of FIG. 1;

FIG. 3 is a side view of the preferred embodiment of a terminal of this invention for a zero insertion force connector;

FIG. 4 is a fragmentary view to illustrate how the terminal of FIG. 4 contacts a pin;

FIG. 5 is a schematic view to illustrate how the terminal of FIG. 3 moves to a first position relative to the pin to separate from the pin; and

FIG. 6 is a schematic view to illustrate how the terminal of FIG. 3 moves to a second position relative to the pin to electrically contact the pin.

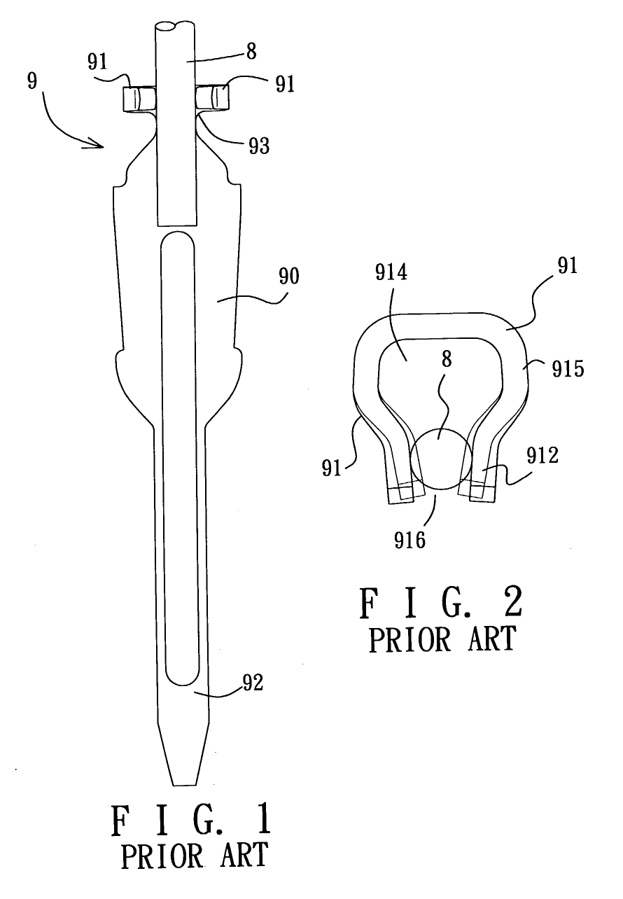

### DETAILED DESCRIPTION OF THE PREFERRED EMBODIMENT

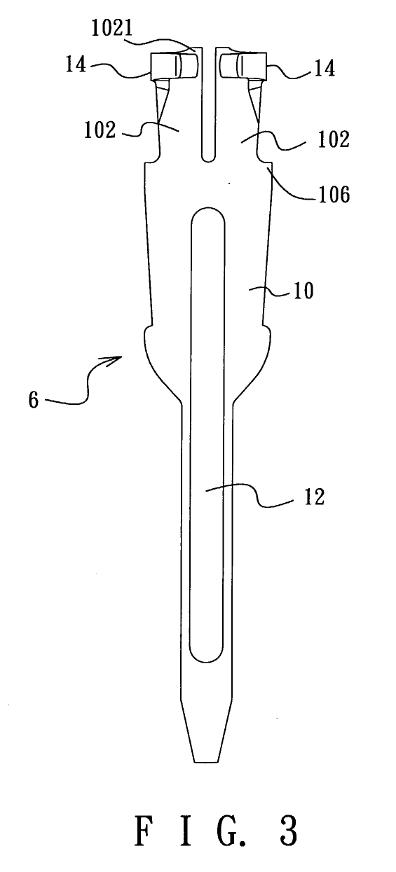

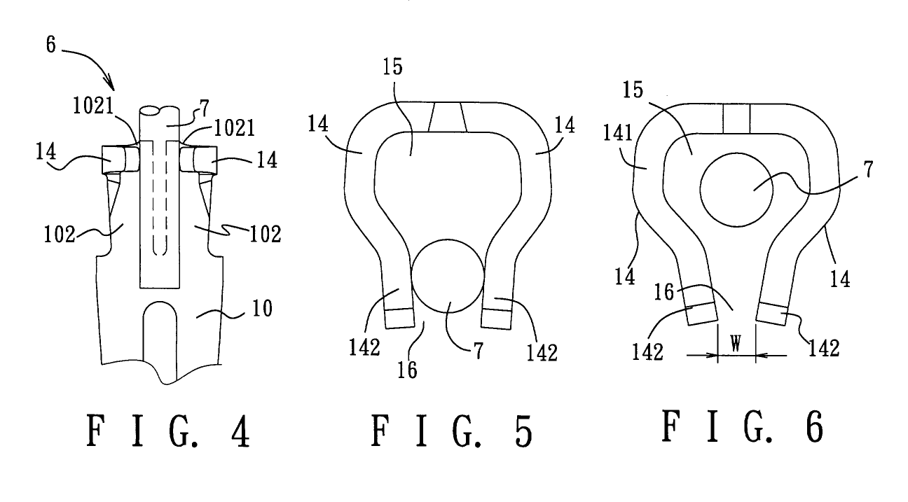

FIGS. 3 and 4 illustrate the preferred embodiment of a terminal 6 of this invention for a zero insertion force (ZIF) connector that is adapted to be surface mounted on a printed circuit board (not shown) for mounting of an electronic device (not shown), such as a CPU, thereon. The ZIF connector is movable so as to permit electrical contact between the terminal 6 and a pin 7 of the CPU. The terminal 6 includes a terminal body 10 that extends in a longitudinal direction and that has a tail 12, a head 106 opposite to the tail 12, and a pair of resilient prongs 102 extending from the head 106 in the longitudinal direction and spaced apart from each other. Each of the prongs 102 has a distal end 1021 that is distal from the head 106. The terminal body 10 further has a pair of opposing spring arms 14 that extend respectively from the distal ends 1021 of the prongs 102 in a transverse direction relative to the longitudinal direction. The spring arms 14 have curved middle sections 141 that cooperatively define a first gap 15 therebetween, and contact ends 142 that extend respectively from the middle sections 141, that are distal from the prongs 102, and that cooperatively define a second gap 16 therebetween. The first gap 15 has a width greater than the diameter of the pin 7. The second gap 16 has a width (W) less than the diameter of the pin 7. When the terminal 6 is moved together with the ZIF connector in the transverse direction from a first position (see FIG. 5), in which the pin 7 is disposed in the first gap 15 and separates from the spring arms 14, to a second position (see FIG. 6), in which the pin 7 is disposed in the second gap 16, the spring arms 14 together with the prongs 102 are resiliently pushed by the pin 7 to move away from each other, which, in turn, results in a restoring force to clamp the pin 7 between the contact ends 142 of the spring arms 14.

The terminal 6 of the present invention is advantageous in that the stress applied by the pin 7 to the spring arms 14 can be partly shifted therefrom to the prongs 102, thereby eliminating the aforesaid drawback as encountered in the prior art.

With the invention thus explained, it is apparent that various modifications and variations can be made without departing from the spirit of the present invention.

I claim:

1. A terminal for a zero insertion force connector, said terminal being adapted to be electrically connected to a pin on an electronic device, said terminal comprising:
a terminal body that extends in a longitudinal direction and that has a tail, a head opposite to said tail, and a pair of resilient prongs extending from said head in said longitudinal direction and spaced apart from each other, each of said prongs having a distal end that is distal from said head, said terminal body further having a pair of opposing spring arms that extend respectively from said distal ends of said prongs in a transverse direction relative to said longitudinal direction, said spring arms having middle sections that cooperatively define a first gap therebetween, and contact ends that extend respectively from said middle sections, that are distal from said prongs, and that cooperatively define a second gap therebetween, said first gap having a width that is greater than the diameter of the pin, said second gap having a width that is less than the diameter of the pin so that when said terminal is moved together with the zero insertion force connector in said transverse direction from a first position, in which the pin is disposed in said first gap and separates from said spring arms, to a second position, in which the pin is disposed in said second gap, said spring arms together with said prongs are resiliently pushed by the pin to move away from each other, which, in turn, results in a restoring force to clamp the pin between said contact ends of said spring arms.
